(19) United States
(12) Patent Application Publication
(10) Pub. No.: US 2025/0202810 A1
(43) Pub. Date: Jun. 19, 2025

(54) SYSTEMS AND METHODS FOR LANGUAGE AGNOSTIC FULL LINK GRAY DEPLOYMENT OF MICROSERVICES AND MIDDLEWARE

(71) Applicant: HUAWEI CLOUD COMPUTING TECHNOLOGIES CO., LTD., Gui Zhou Province (CN)

(72) Inventors: Adalberto Ribeiro Sampaio Junior, Kanata (CA); Jun GAN, Kanata (CA); Shiqi WANG, Shenzhen (CN); Jieshui MO, Shenzhen (CN)

(73) Assignee: HUAWEI CLOUD COMPUTING TECHNOLOGIES CO., LTD., Gui Zhou Province (CN)

(21) Appl. No.: 18/540,410

(22) Filed: Dec. 14, 2023

(51) Int. Cl. H04L 45/50; H04L 67/56

(52) U.S. Cl. CPC H04L 45/50; H04L 67/56

(57) ABSTRACT

According to one or more aspects, apparatus, systems, and methods may be provided for language agnostic full link gray deployment of microservices and middleware. According to an aspect a method may be provided for propagating and routing traffic between microservices of an application. The method includes receiving, at a plugin of a proxy corresponding to a service of the application, an outbound request from the service. The outbound request may indicate a trace identifier (ID) identifying a trace of the outbound request in the application. The method may further include assigning, by the plugin, a custom label to the outbound request. The custom label may be associated with the trace ID and indicate a version of the application towards which the outbound request is to be routed. The method may further include sending, by the plugin to a router of the proxy, the outbound request for routing.

### CROSS-REFERENCE TO RELATED APPLICATIONS

This is the first application filed for the present invention.

### FIELD OF THE INVENTION

The present invention pertains to the field of application development, and in particular to systems and methods for language agnostic deployment of microservices and middleware.

### BACKGROUND

Deploying microservices in a production environment is important for agile and scalable service delivery. However, existing deployment techniques come with certain limitations that organizations need to navigate. One common approach involves running two versions of the entire application in production, allowing for seamless migration and rollback. While effective, this approach can be costly and resource-intensive, particularly for larger applications. Another limitation is that many deployment techniques primarily support traffic splitting at the entry point of the system, making it challenging to manage individual microservices independently. Language-specific deployment methods, although efficient for specific stacks, can lack flexibility and create complexities when integrating diverse technologies. Moreover, there is often a lack of support for routing traffic between services and middleware, which hinders the optimization of communication pathways in a microservices architecture.

Therefore, improvements in language agnostic deployment of microservices and middleware are desirable.

This background information is provided to reveal information believed by the applicant to be of possible relevance to the present invention. No admission is necessarily intended, nor should be construed, that any of the preceding information constitutes prior art against the present invention.

### SUMMARY

According to one or more aspects, apparatus, systems, and methods may be provided for language agnostic full link gray deployment of microservices and middleware. According to an aspect, a method may be provided for propagating and routing traffic within an application. The method includes receiving, at a plugin of a proxy corresponding to a service of an application, an outbound request from the service. The outbound request may indicate a trace identifier (ID) identifying a trace of the outbound request in the application. The method may further include assigning, by the plugin, a custom label to the outbound request. The custom label may be associated with the trace ID and indicate a version of the application towards which the outbound request is to be routed. The method may further include sending, by the plugin to a router of the proxy, the outbound request for routing.

The method may further include obtaining, by the plugin, the custom label from a shared in-memory storage of the proxy. The method may further include receiving, at the plugin, an inbound request corresponding to the outbound request. The inbound request may indicate the trace ID and the custom label. The method may further include storing, by the plugin, the trace ID and the custom label in the shared in-memory storage. The method may further include sending, by the plugin to the service, the inbound request for processing.

In some embodiments, the service may be a first version of a first service of the application. In some embodiments, the version of the application may be a second version of a second service of the application towards which the outbound request is to be routed. The second version may be the first version or a different version.

In some embodiments, the service may be a first service of a first version of the application. The first version of the application may include a first set of services of the application including the first service. In some embodiments, the custom label may indicate a second version of the application running in parallel to the first version of the application. The second version of the application may include a second set of services of the application.

According to another aspect, another method may be provided propagating and routing traffic within an application. The method includes receiving, at a plugin of a proxy corresponding to a first service of an application, a request indicating a trace ID identifying a trace of the request in the application. The first service may be in a first lane of the application. The first lane of the application may correspond to a first version of the application. The first version of the application may include a first set of services of the application including the first service. The method may further include sending, by the plugin to a second service in a second lane of the application, the request. The second lane of the application may correspond to a second version of the application running in parallel to the first version of the application. The second version of the application may include a second set of services of the application including the second service. The method may further include receiving, at a second plugin of a second proxy of a second service in the first lane from the second lane, the request.

In some embodiments, receiving, at the plugin of the proxy corresponding to the first service, the request may include receiving, at the plugin of the proxy corresponding to the first service of the application, an inbound request. The inbound request may indicate the trace ID and a custom label. The custom label may be associated with the trace ID and indicate the second version of the application towards which the request is to be routed. Receiving, at the plugin of the proxy corresponding to the first service of the application, the request may further include storing, by the plugin of the proxy corresponding to the first service, the trace ID and the custom label in a shared in-memory storage. Receiving, at the plugin of the proxy corresponding to the first service of the application, the request may further include sending to the first service, by the plugin of the proxy corresponding to the first service, the inbound request for processing.

In some embodiments, sending, by the plugin to the second service in the second lane of the application, the request may include receiving, at the plugin of the proxy corresponding to the first service, an outbound request from the first service. The outbound request may indicate the trace ID. Sending, by the plugin to the second service in the second lane of the application, the request may further include obtaining, by the plugin of the proxy corresponding to the first service, the custom label from the shared in-memory storage. Sending, by the plugin to the second service in the second lane of the application, the request may further include assigning, by the plugin of the proxy corresponding to the first service, the custom label to the outbound request. Sending, by the plugin to the second service in the second lane of the application, the request may further include sending, by the plugin of the proxy corresponding to the first service to a router of the proxy, the outbound request for routing.

According to an aspect, a method may be provided for routing traffic from an application service to a middleware. The method includes receiving, by a proxy corresponding to a service of an application, an outbound request from the service. The service may correspond to a version of the service. The method may further include obtaining, by the proxy corresponding to the service of the application, an address of a middleware towards which the outbound request is to be routed. The method may further include routing, by the proxy corresponding to the service of the application, the outbound request to the middleware based on the address of the middleware.

In some embodiments, obtaining, by the proxy corresponding to the service of the application, an address of a middleware towards which the outbound request is to be routed may include obtaining, by the proxy corresponding to the service of the application, a version of the middleware based on the version of the service. Obtaining, by the proxy corresponding to the service of the application, an address of a middleware towards which the outbound request is to be routed may further include obtaining, by the proxy corresponding to the service of the application, the address of the middleware based on the version of the middleware.

In some embodiments, obtaining, by the proxy corresponding to the service of the application, a version of the middleware based on the version of the service may include matching, by the proxy corresponding to the service of the application, the version of the service to the version of the middleware via a registry center. The registry center may indicate a version of each: service of the application and middleware of the application.

In some embodiments, the method may further include receiving, by the proxy corresponding to the service of the application, a matching source label routing policy. Matching, by the proxy corresponding to the service of the application, the version of the service to the version of the middleware may include matching according to the matching source label routing policy.

According to another aspect, an apparatus may be provided. The apparatus includes modules or electronics configured to perform one or more of the methods and systems described herein.

According to one aspect, an apparatus may be provided, where the apparatus includes: a memory, configured to store a program; a processor, configured to execute the program stored in the memory, and when the program stored in the memory is executed, the processor is configured to perform one or more of the methods and systems described herein.

According to another aspect, a computer readable medium may be provided, where the computer readable medium stores program code executed by a device and the program code is used to perform one or more of the methods and systems described herein.

According to one aspect, a chip may be provided, where the chip includes a processor and a data interface, and the processor reads, by using the data interface, an instruction stored in a memory, to perform one or more of the methods and systems described herein. Aspects may further include the memory.

Other aspects of the disclosure provide for apparatus, and systems configured to implement the methods according to the first aspect disclosed herein. For example, wireless stations and access points can be configured with machine readable memory containing instructions, which when executed by the processors of these devices, configures the device to perform one or more of the methods and systems described herein.

Embodiments have been described above in conjunctions with aspects of the present invention upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 illustrates a system architecture to which one or more aspects may apply, according to an embodiment.

FIG. 2 illustrates a traffic flow diagram at an application service, according to an embodiment.

FIG. 3 illustrates a flowchart of a method for propagating and routing traffic, according to an embodiment.

FIG. 4 illustrates a flowchart of a method for routing traffic to a middleware, according to an embodiment.

FIG. 5 illustrates a flowchart of a method for propagating and routing traffic within an application, according to an embodiment.

FIG. 6 illustrates a flowchart of a method for propagating and routing traffic within an application, according to an embodiment.

FIG. 7 illustrates a flowchart of a method for routing traffic from an application service to a middleware, according to an embodiment.

FIG. 8 illustrates an apparatus that may perform any or all of operations of the methods and features explicitly or implicitly described herein, according to different aspects of the present disclosure.

It will be noted that throughout the appended drawings, like features are identified by like reference numerals.

### DETAILED DESCRIPTION

According to one or more aspects, apparatus, systems, and methods may be provided for language agnostic full link gray deployment of microservices and middleware. According to an aspect a method 500 may be provided for propagating and routing traffic between microservices of an application. The microservices may include one or more services of a first or base version and one or more services of a second or gray version. The method includes receiving, at a plugin of a proxy corresponding to a service of the application, an outbound request from the service. The outbound request may indicate a trace ID identifying a trace of the outbound request in the application. The method may further include assigning, by the plugin, a custom label to the outbound request. The custom label may be associated with the trace ID and indicate a version of the application towards which the outbound request is to be routed. The method may further include sending, by the plugin to a router of the proxy, the outbound request for routing.

According to another aspect, another method 600 may be provided for propagating and routing traffic within an application. The application may have a first lane comprising one or more services of a first or base version of the application. The application may have a second lane comprising one or more services of a second or gray version of the application running in parallel with the one or more services of the first version of the application. The method may include receiving, at plugin of a proxy corresponding to a first service of the application, a request indicating a trace ID identifying a trace of the request in the application. The first service may be in a first lane of the application. The first version of the application may include a first set of services of the application including the first service. The method may further include sending, by the plugin to a second service in the second lane of the application, the request. The method may further include receiving, at a second plugin of a second proxy of a second service in the first lane from the second lane, the request.

According to another aspect, a method 700 may be provided for routing traffic from an application service to a middleware. The method may include receiving, by a proxy corresponding to a service of an application, an outbound request from the service. The service may correspond to a version of the service. The method may further comprise obtaining, by the proxy corresponding to the service of the application, an address of a middleware towards which the outbound request is to be routed. The method may further include routing, by the proxy corresponding to the service of the application, the outbound request to the middleware based on the address of the middleware.

In the context of the present disclosure, a blue-green deployment may refer to a deployment strategy that transfers all users traffic from a previous version of an application or microservice to a new release (e.g., a new version of the application or microservice). The term microservice and service may be used interchangeably herein as can be understood from the context used.

In the context of the present disclosure, a canary or gray release may refer to a deployment strategy that gradually transfers the users' traffic from a previous version of an application or microservice to a new release. A full link canary (or gray) deployment may refer to the complete chain of microservices that are involved in serving a request within an application. All microservices along the link (or chain) may share the same trace ID.

In the context of the present disclosure, a “full link” (“end-to-end,” “full path,” or “complete chain”) may refer to the sequence of interactions or processes that a request or data goes through as it traverses the various components or services within an application. It often encompasses the journey from the point of entry (e.g., a client request) through all the microservices and components involved until a response is generated and returned to the client.

In the context of the present disclosure, middleware may refer to software that lies between an operating system and the applications running on it. A middleware may refer to, for example, a database, Redis™ etc. in the context of deployment of microservices.

In the context of the present disclosure, a microservice gateway may serve as an entry point to provide a simple, yet effective way to route and forward traffic to the appropriate backend service and provide cross cutting concerns to backend service such as: security and monitoring (or metrics).

In the context of the present disclosure, a sidecar proxy (e.g., a proxy) may refer to a type of software that runs alongside a microservice to intercept inbound traffic and decouple cross-cutting concerns such as traffic management, security, monitoring, and resiliency.

In the context of the present disclosure, a label may refer to a hypertext transfer protocol (HTTP) header which is used to add extra information to a request. A standard label may refer to a label defined in one standard for context propagation. B3 Propagation and W3C (World Wide Web Consortium) may be understood as common standards for context propagation. B3 Propagation is a specification for the header “b3” and those that start with “x-b3-”. These headers are used for trace context propagation across service boundaries. In some embodiments, a custom label may refer to a label used in-house for specific operations, e.g., load testing (X-Load-Testing) or gray deployment (X-Gray-Deployment).

In the context of the present disclosure, a trace may refer to an ordered list of requests. Each trace may have a trace identifier (trace ID) linking all services involved in processing the one or more requests in the trace within an application. A trace (or trace ID) is important to understand the full “path” a request may take in an application. A trace ID may be an HTTP header with a unique identifier common to all requests in a corresponding trace. A label (tag) propagation may refer to the act of propagating or cascading information throughout the full link.

In the context of the present disclosure, a service lane may refer to the chain of the services grouped under a same label. A base service-lane may refer to the original chain of the services running in the production. A gray service-lane may refer to the chain of services that are in a different version compared to the version in base service-lane.

In the context of the present disclosure, a web assembly (WASM) may refer to a binary instruction format for a stack-based virtual machine. A WASM may be designed as a portable compilation target for programming languages, enabling deployment on the web for client and server applications. A WASM plugin may refer to a module that extends (e.g., seamlessly) the capabilities of a host software (e.g., a proxy) without the need for restarts, for example, adding extra capabilities (e.g., Authentication, Validation) to a sidecar. A plugin may refer to a separate piece of code that can extend the functionality of a core software without requiring modifications to the core codebase. A production environment may refer to the operational environment where a software application runs and serves customers. A production environment refers to the live and active environment where the software is deployed for its intended purpose.

When conducting a full link gray (or canary) deployment for microservices in production environment, there needs to be a way to logically separate the traffic between the base version and the gray version throughout the link (or chain).

Having two versions of an entire application in production (e.g., blue-green mode) may be costly as it may require cloning the environment for the newer version (gray version). Furthermore, there may only be a few microservices that need to be updated at a time. In addition, the traffic routing strategy needs to be consistent throughout the chain (i.e., not only at the entry point). The traffic may need to fall back to the base version in case the gray version is not available for the services in the chain.

Typically, there are various communication protocols used between microservices (e.g., HTTP) and middleware (e.g., transmission control protocol (TCP) for database (DB)), which makes it difficult to apply, for example, conventional HTTP header-based approach for routing traffic to gray version of DB.

Some existing solutions, such as the blue/green-based solution, for deploying a new version of an application (or one or more microservices) may involve physically setting up two sets of infrastructures (one for each version of services or middleware). A limitation of the current deployment approaches is that most of them only support traffic splitting at the entry point of the system or only support a single service scenario.

Other existing solutions are language specific solutions such as the software development kit (SDK) based approach and the Java agent-based approach. These language-based approaches require developing a corresponding solution for each programming language.

Another limitation of the current approaches is that they may not support generic service to middleware traffic routing in multi-language scenario. Microservices usually communicate using textual protocols such as HTTP/1.1, HTTP/2 (e.g., Google™ remote procedure call (gRPC)) that can be marked with labels, while middleware usually communicates using binary protocols such as Redis™ and MySQL™ that cannot be marked. Further, current solutions rely on built-in features in the application which may be heavy (e.g., the built-in features may make the application relatively large or resource-intensive) and not extensible or pluggable, thereby limiting the application's flexibility, scalability, and adaptability.

When conducting full link gray (or canary) deployment for microservices and middleware in production environment, one or more aspects of the disclosure may allow the traffic between a base version and a gray version to be logically separated throughout the service and middleware link (or chain). Some aspects may allow for the traffic routing strategy along the link (or chain) to be consistent throughout the chain (i.e., not only at the entry point). Some aspects of the disclosure may allow the traffic to fall back to the base version in case the gray (newer) version of a service or middleware is not available in the link (or chain).

Applying a conventional HTTP header-based approach for routing traffic to a gray version of DB may be difficult since a different communication protocol is used for service-to-service traffic routing (e.g., HTTP) than one used for service-to-middleware traffic routing (e.g., TCP for DB). Accordingly, in addition to service-to-service traffic routing, some aspects of the disclosure may provide a generic solution to support service to middleware traffic routing under multi-language scenarios. One or more aspects may support service-to-middleware traffic routing to address the different communication protocols used.

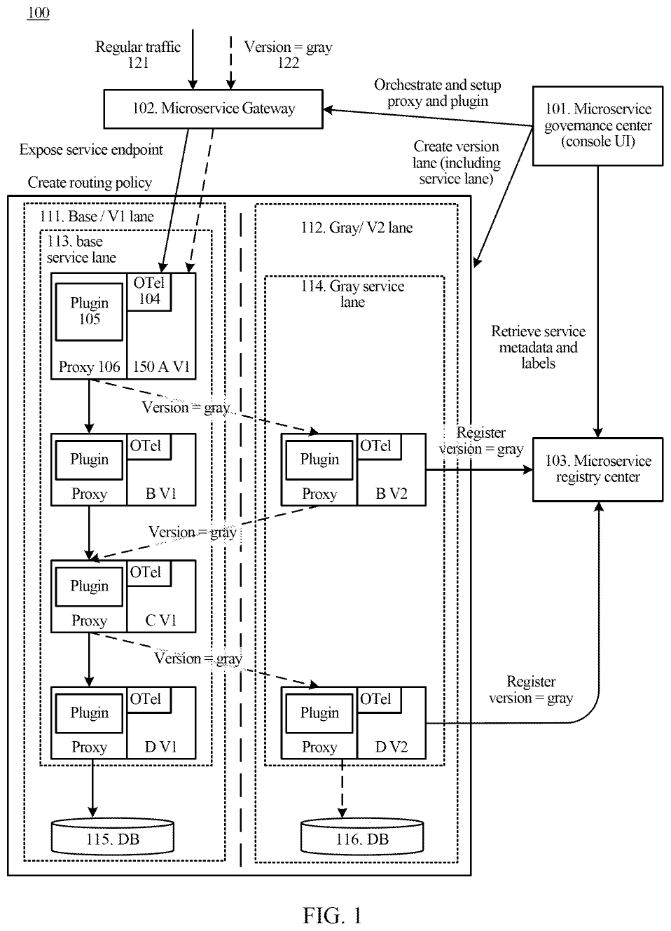

FIG. 1 illustrates a system architecture to which one or more aspects of the present disclosure may apply, according to an embodiment. The system architecture 100 may refer to an architecture for deploying one or more new microservices (or services) of an application.

The system architecture 100 may include a microservice governance center (console user interface (UI)) 101. The microservice governance center 101 may provide a unified UI for users to apply coherence policies (e.g., rate limiting, circuit breaker, full link, etc.). The microservice governance center 101 may further communicate with a microservice gateway 102 to orchestrate the setup of a proxy as a service sidecar. The microservice governance center 101 may further manage the installation of the full link WASM plugin (or plugin) into all sidecars and create version lanes including service lanes with routing policies.

In an embodiment, the microservice governance center 101 may generate a base lane 111 (or a first version or version 1 (V1) lane) corresponding to a first version of an application and a gray lane 112 (or a second version or version 2 (V2) lane) corresponding to a second version of an application. The base lane 111 may comprise a first set of services (e.g., existing services A V1, B V1, C V1, and D V1) of the application indicated via the base service lane 113. The base lane 111 may further comprise supporting infrastructure that supports the first set of services (e.g., database (DB) 115, message queues, caching systems, other backend components). The base lane 111 may further comprise networking configuration, connectivity components and configuration data among others.

The gray lane 112 may comprise a second set of services (e.g., new services B V2 and D V2) of the application indicated via the gray service lane 114. The gray lane 112 may further comprise corresponding supporting infrastructure that supports the second set of services (e.g., a database (DB) 116, message queues, caching systems, other backend components). The gray lane 112 may further comprise corresponding networking configurations, connectivity components and configuration data among others.

The system architecture 100 may further include the microservice gateway 102, which may manage the installation of proxies and plugins, expose service endpoints, and install routing policies. The microservice gateway 102 may further communicate with the microservice governance center 101 to apply routing policies to proxy sidecars.

The system architecture 100 may further include a microservice registry center 103. The microservice registry center 103 may store and make available service metadata such as the number of instances of each service running in the application, service labels, and service names. The microservice registry center 103 may be used by the microservice gateway to discover available services and their endpoints.

In an embodiment, an OpenTelemetry (OTel) 104 is an observability SDK used by each application service to identify the full link of the application through automatic handling of trace IDs across services. For example, when traffic e.g., regular traffic 121 or gray traffic 122, is flowing through an application service AV1 150, OTel 104 may correlate the inbound and outbound requests. When an inbound request arrives at the application service AV1 150, OTel 104 may intercept the inbound request and mark the inbound request with a label, e.g., trace ID. Similarly, when an outbound request is fired or sent from the application service, OTel 104 may intercept the outbound request and mark it with the same trace ID label. Thus, OTel 104 may be used to mark corresponding inbound and outbound requests with the same label, e.g., the trace ID. Frameworks other than OTel may also be used to perform similar functions to those of OTel.

As mentioned, the microservice governance center 101 in combination with the microservice gateway 102 may orchestrate the setup of proxy (e.g., proxy 106) as a sidecar at each application service. The microservice gateway 102, in communication with the microservice governance center 101, may manage the installation of a proxy (e.g., proxy 106) and a plugin (e.g., plugin 105) for each application service. In an embodiment, a plugin (e.g., plugin 105) may be installed into a corresponding proxy (e.g., proxy 106). The proxy 106 may be a service sidecar that hosts the plugin 106 and enforces routing policies installed by the microservice gateway 102. The proxy 106 may be managed by the microservice governance center 101. In an embodiment, the plugin 105 (or the full link WASM plugin) may perform custom label propagation through the full link identified by OTel 104 as described herein in one or more aspects.

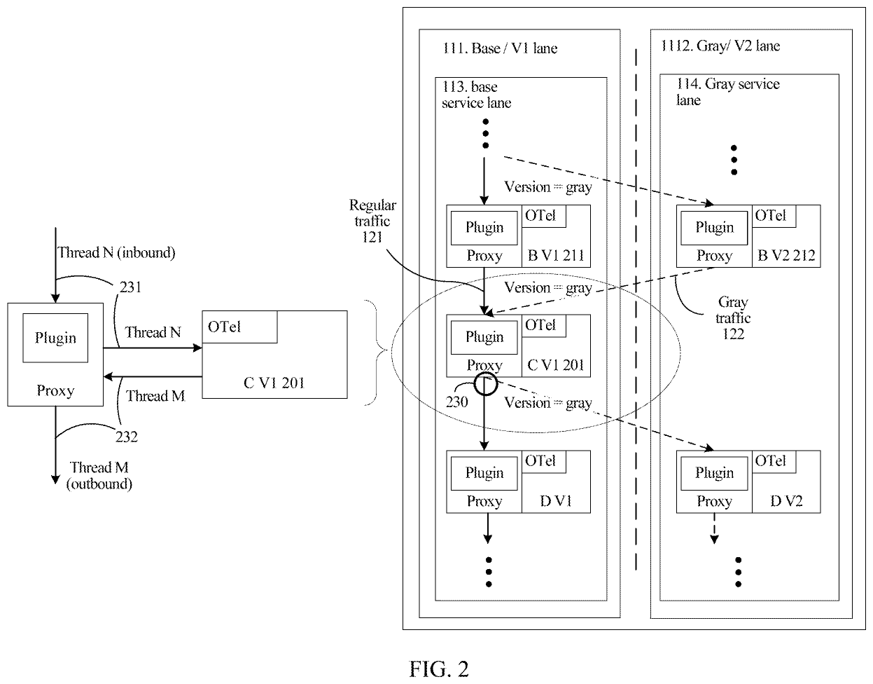

FIG. 2 illustrates a traffic flow diagram at an application service, according to an embodiment. When one or more new application services, referring to the gray lane 112, are deployed, isolating or separating the regular traffic from the gray traffic is desirable. For example, when an application service, e.g., application service C V1 201, may be shared between the two versions, the base version (by application service B V1 211) and the gray version (by application service B V2 212), isolating the regular traffic 121 from the application service B V1 211 from gray traffic 122 (from application service B V2 212) may be desirable to determine the outgoing traffic 230 from application service C V1 201. Currently, existing solutions for deploying a new service are limited to traffic splitting only at entry point, and as such, these solutions would be inadequate to determine whether the outgoing traffic 230 is a regular traffic 121 or a gray traffic 122.

The limitation to identify outgoing traffic may be partly based on using different threads for handling inbound requests and handling outbound requests. Inbound requests may be handled by inbound request threads (e.g., thread N 231) which receive, process and route incoming requests from external sources to appropriate components within a microservice. Outbound requests may be handled by outbound request threads (e.g., thread M 232) which manage communication with external sources. Inbound request threads and outbound requests threads may be unable to share data from the requests they handle, which may prevent the propagation of custom labels between incoming and outgoing requests.

According to an aspect, a plugin may be provided that allows an inbound request thread and an outbound request thread to share data or information. The plugin may be referred to as a full link WASM plugin or a plugin. According to an aspect, the plugin may allow the propagation of custom labels between incoming and outgoing requests. As a result, traffic of different versions of an application may be isolated along the full link.

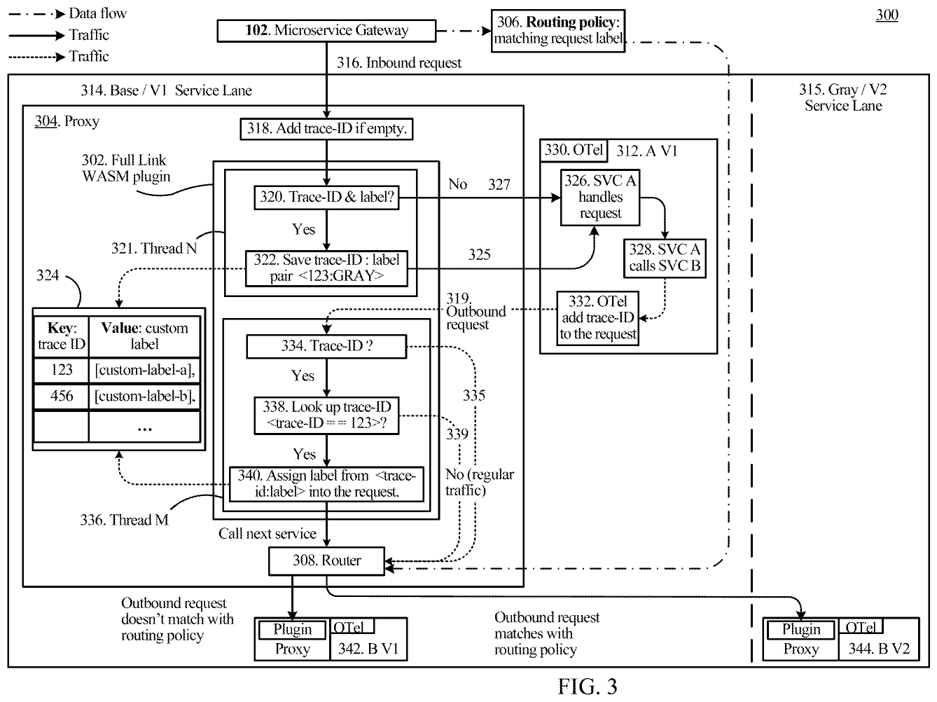

FIG. 3 illustrates a flowchart of a method 300 for propagating and routing traffic, according to an embodiment. The method 300 may allow for propagating and routing custom labels or custom tags through a full link WASM plugin. Accordingly, a full link WASM plugin 302 may be implemented to propagate and route traffic through an application. The application may deploy one or more new services (or microservices) alongside existing services. The one or more new services may be deployed in the gray or version 2 (V2) service lane 315. The existing services may be running in the base or version 1 (V1) service lane 314.

According to an embodiment, method 300 may include configuring a proxy 304 with a matching request label routing policy 306. For example, microservice gateway 102 may configure a router 308 corresponding with the proxy 304 with a matching request label policy 306. Proxy 304 may be associated with or correspond to an application service A V1 312 in a first version or base service lane 314 of the application.

Proxy 304 may be the runtime for the full link WASM plugin 302. Runtime may refer to the environment in which the code of the plugin (the full link WASM plugin 302) executes or operates. For example, proxy 304 may be responsible for certain aspects of the plugin's behavior or execution while the plugin is actively running within an application or system. The proxy may be an intermediary component or layer that acts as an interface or go-between. It can intercept and handle certain interactions between the application or system and the plugin. Thus, proxy 304 may be involved in managing or controlling the interactions and behavior of the plugin while it's in the active, running state.

In an embodiment, method 300 may include a request, e.g., an inbound request 316, arriving at the system (comprising application service A V1 312 and its associated proxy 304), through an entry point, which may be the microservice gateway 102. The proxy 304 may intercept and handle 318 the inbound request. The inbound request may be labeled with a trace ID and a custom label. The custom label or label may indicate a version of the application, e.g., the version of an application service towards which the request (e.g., an outbound request 319 corresponding to the inbound request 316) should be or is to be routed. In some embodiments, handling 318 the inbound request may comprise determining whether the inbound request indicates a trace ID, and adding the trace ID to the inbound request if the inbound request does not indicate the trace ID.

Method 300 may further include, the full link WASM plugin 302, receiving the inbound request 316. The full link WASM plugin 302 may receive the inbound request 316 via an inbound request thread 321 (e.g., thread N). The full link WASM plugin 302 may, via the inbound request thread 321, check 320 the inbound request to obtain the trace ID and the custom label. The full link WASM plugin 302, via the inbound request thread 321, may obtain the trace ID and the custom label from the inbound request and save 322 the pair, <trace ID: custom label> (e.g., <123: gray>), in a shared in-memory storage 324. In some embodiments, the shared-memory storage 324 may be a simple hash table (e.g., a map), where the key is the trace ID, and the value is the actual label being propagated, e.g., custom label. For example, the shared-memory storage 324 may indicate a hash table based on the following format: <key, custom label>: e.g., in the case of two entries, the hash table may be: <123: custom-label-a>, and <456: custom-label-b>.

After saving the pair, the full link WASM plugin 302, via the inbound request thread 321, may then dispatch or send 325 the inbound request to the application service A V1 312 for processing. In some embodiments, the inbound request may only include a trace-ID and not include the custom label. In such embodiments. the full link WASM plugin 302, via the inbound request thread 321, may then dispatch or send 327 the inbound request to the application service A V1 312 for processing.

The application service A V1 312 may process or handle 326 the inbound request. After handling the inbound request, the application service A V1 312 may further call 328 a next application service B. In calling the next application service B, application service A V1 312 may generate an outbound request 319 and send or route the outbound request to the next application service B in the link. OTel 330 corresponding to the application service A V1 312 may intercept the outbound request and add or inject 332 the trace ID of the inbound request 316 that initiated the outbound request to the outbound request 319.

Method 300 may further include, the full link WASM plugin 302 (i.e., proxy 304) intercepting the outbound request and checking 334, via an outbound request thread 336, the outbound request for a trace ID. In some embodiments, if the full link WASM plugin 302 determines, via the outbound request thread 336, that the outbound request 319 does not indicate the trace ID and label, then the outbound request is treated as regular traffic 335 and sent to the router 308 for transmission.

In some embodiments, if the outbound request 319 indicates a trace ID, then, the full link WASM plugin 302 may look up or search 338, via the outbound request thread 336, the trace ID from the outbound request in the shared in-memory data storage 324 for a corresponding custom label. In some embodiments, if the full link WASM plugin 302, determines, via the outbound request thread 336, that shared in-memory data storage 324 does not include the trace ID (i.e., the trace ID cannot be found in the shared in-memory data storage 324), then the outbound request may be treated as regular traffic 339 and sent to the router 308 for transmission.

In some embodiments, if the full link WASM plugin 302 identifies or finds a match of the trace ID in the shared in-memory data storage 324, then the full link WASM plugin 302 may obtain the custom label associated with the identified trace ID in the in-memory data storage and assign or add 340, via the outbound request thread 336, the custom label to the outbound request. The full link WASM plugin 302 may then send the labelled outbound request to router 308 for transmission to the next service.

Method 300 may further include the proxy 304 forwarding, via router 308, the outbound request to the next service. The next service may be an application service B V1 342 within the same base service lane 314 as service A V1 312 or an application service B V2 344 in the gray service lane 315. Forwarding the outbound request may include matching the outbound request's custom label with the available routing rules or policies. Accordingly, proxy 304 may forward the outbound request to either application version B V1 342 or B V2 344 of the next service, by matching the request's custom label with the available routing rules.

In some embodiments, if the custom label in the outbound request does not match a routing policy, then the outbound request may be forwarded within the same service lane, e.g., the outbound request is forwarded to application service B V1 342. In some embodiments, if the custom label in the outbound request matches a routing policy, then the outbound request may be forwarded according to the routing policy (which may indicate to either forward the outbound request within the same base lane 314 or to gray service lane 315). For example, the custom label in the outbound request may match a routing policy that indicates that the outbound request should be routed to application service B V2 344 in the gray service lane 315. Then, proxy 304 may forward the outbound request to application B V2 344.

As traffic is routed through one or more services of an application, at each application service (e.g., at each hop involving an application service in the application), the traffic (e.g., the inbound request and outbound request) may undergo similar operations as described in reference to proxy 304 and full link WASM plugin 302 in FIG. 3.

Routing traffic from an application service to a middleware is another challenge that existing solutions may be inadequate to perform, particularly in a multi-language scenario. As mentioned herein, microservices usually communicate using textual protocols that can include label marking while middleware usually communicates using binary protocols. However, binary protocols may not support propagating labels as textual protocols do. Therefore, routing traffic from an application service to a middleware according to their lanes (e.g., allowing label propagating) may be desirable.

According to an aspect, traffic may be routed from an application service to a middleware. The middleware may be in the same lane as the application service or in a different lane, as may be determined by a custom label accompanying the traffic. Accordingly, a generic mechanism may be provided to enable the traffic routing between an application service and a middleware.

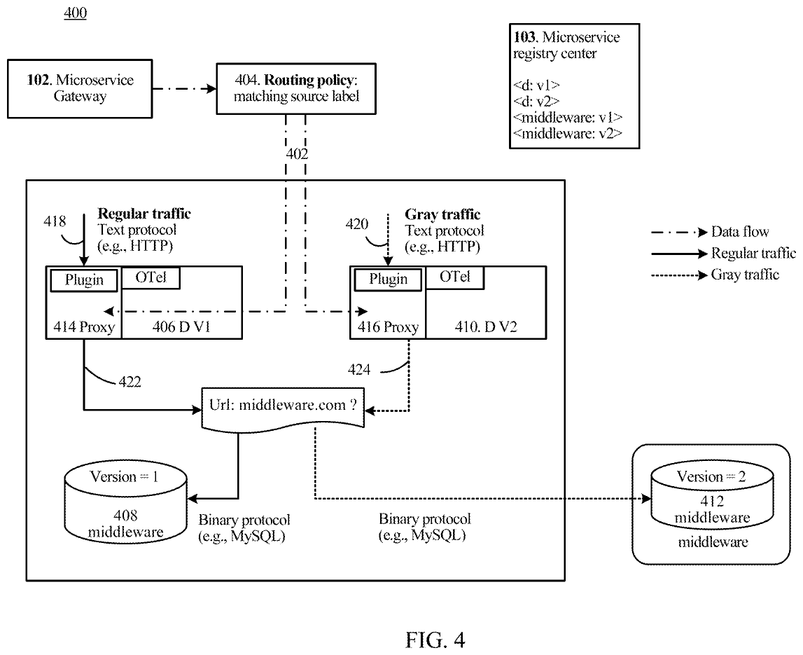

FIG. 4 illustrates a flowchart of a method 400 for routing traffic to a middleware, according to an embodiment. Method 400 may include configuring 402 one or more proxies (or each proxy) of each version of the application with a matching source label routing policy 404. In some embodiments, the microservice gateway 102 may configure or be involved in configuring one or more proxies at each version of the application.

In an embodiment, an application may have a first or base lane corresponding to a first or base version of the application. The first lane may include application service D V1 406 and middleware 408. Although not shown, the application may have one or more other services (and corresponding one or more proxies) in the first lane.

The application may further have a second or gray lane corresponding to a second or gray version of the application. The second lane may include application service D V2 410 and middleware 412. Although not shown, the application may have one or more other services (and corresponding one or more proxies) in the second lane.

In an embodiment, configuring one or more proxies of each version of the application may comprise configuring proxy 414 associated with application service D V1 406 at the first lane. Configuring one or more proxies of each version of the application may further comprise configuring proxy 416 associated with application service D V2 410 at the second lane.

Method 400 may further include registering in the microservice registry center 103 the name and version of the one or more application services and middleware. There may be multiple instances of an application service or a middleware. Thus, application service D V1 406 and D V2 410 are registered at the microservice registry center 103. Further, middleware 408 and 412 are also registered at the microservice registry center 103. During registration, each middleware instance may be assigned a label indicating a version of the application to which the middleware is associated.

In some embodiments, a middleware may refer to an auxiliary component that provides some infrastructure to the application, for example, a database for storing data. A middleware at a corresponding lane can be associated with or relate to one or more services in the same corresponding lane.

Method 400 may further include handling, by a proxy of an application service, an inbound request for a given application service labeled, e.g., service D V1 406 or service D V2 410. For example, proxy 414 corresponding to the application service D V1 406 may handle an inbound request 418 associated with regular traffic and labeled with application service D V1 406. Proxy 414 may pass the inbound request to the application service D V1 406, which processes the inbound request and fires an outbound request 422 to be routed to a target middleware. Similarly, proxy 416 corresponding to the application service D V2 410 may handle an inbound request 420 associated with gray traffic and labeled with application service D V2 410. Proxy 416 may pass the inbound request to the application service D V2 410, which processes the inbound request and fires an outbound request 424 to be routed to a target middleware.

The proxy associated with each application service may intercept the outbound request. The proxy may identify the target middleware based on the application service that is firing the outbound request. The proxy may identify the target middleware instance by matching the version (label) of the application service that fired the outbound request with the version (label) of the target middleware registered in the microservice registry center 103. Thus, the proxy may resolve the url “middleware.com” with the address of the matched middleware.

For example, application service D V1 406 may fire an outbound request, and proxy 414 may resolve the target middleware instance by matching the label (e.g., version) of the application service D V1 406 with the label of the target middleware registered in the microservice registry center 103. Proxy 414 may determine that the application service D V1 406 has a label, e.g., V1, indicating a first or base version of the application service D V1 406. Proxy 414 may then match the label, e.g., V1, of the application service D V1 406 with a middleware having the same label, e.g., V1, registered in the microservice registry center 103. The matched middleware may then be target middleware of the outbound request 422. Proxy 414 may then resolve the url “middlware.com” with the address of the matched middleware. Proxy 414 may then forward the outbound request 422 to the matched middleware, e.g., middleware 408, based on an address of the matched middleware.

Similarly, application service D V2 410 may fire an outbound request, and proxy 416 may resolve the target middleware instance by matching the label (e.g., version) of the application service D V2 410 with the label of the target middleware registered in the microservice registry center 103. Proxy 416 may determine that the application service D V2 410 has a label, e.g., V2, indicating a second or gray version of the application service D V2 410. Proxy 416 may then match the label, e.g., V2, of the application service D V2 410 with a middleware having the same label, e.g., V2, registered in the microservice registry center 103. The matched middleware may then be the target middleware of the outbound request 424. Proxy 416 may then resolve the url “middlware.com” with the address of the matched middleware. Proxy 416 may then forward the outbound request 424 to the matched middleware, e.g., middleware 412, based on an address of the matched middleware.

One or more aspects described herein may be implemented in or applicable to various cloud middleware systems for microservice applications. One example of identifying end-to-end traffic isolation and routing in multi-language scenario according to one or more embodiments may involve a user initiating labeled (e.g., gray) service call to the entry service and request the operation logs to detect and verify if the labeled request traffic flow through the gray version of the service along the service chain, with no requests leaking to the base version.

One example of determining service to middleware (e.g., RDS) routing in multi-language scenario according to one or more embodiments may involve a user can initiating a labeled (e.g., gray) service call to the entry service and request the operation logs to detect and verify if the labeled request traffic hit the gray (a.k.a. shadow) version of the middleware (e.g., DB), with no requests leaking to the base version.

One example of identifying a plugin-based lightweight extensible solution (support hot deployment & on-demand enable/disable) according to one or more embodiments may involve a user removing/disabling the plugin and requesting the operation logs to detect and confirm if system is still up and running without disruption. After removal, requests may be load balanced between the two versions.

One or more aspects may provide for propagating and routing custom label (or custom tag) through full link WASM plugin. The propagation and routing of the custom label may be done in a language agonistic approach which may be lightweight compared to conventional language specific & non WASM-based plugin approaches.

One or more aspects may provide for routing traffic from an application service to a middleware (gray version or shadow version) in a more generic approach compared to conventional middleware specific solutions.

One or more aspects may apply to cloud applications where a high demand exists for full link gray deployment solutions to verify a new version in real production environment in a safe and cost-efficient manner. Conventionally, users need to set up two separate infrastructures.

According to an aspect, the language agnostic full link label propagation and traffic routing capabilities may also apply to online full link load testing scenario. Online full link load testing has been widely used, for example, by Amazon, Alibaba and other online retailers to ensure system's resilience and performance before the big sales event (e.g., Black Friday, Singles' Day)

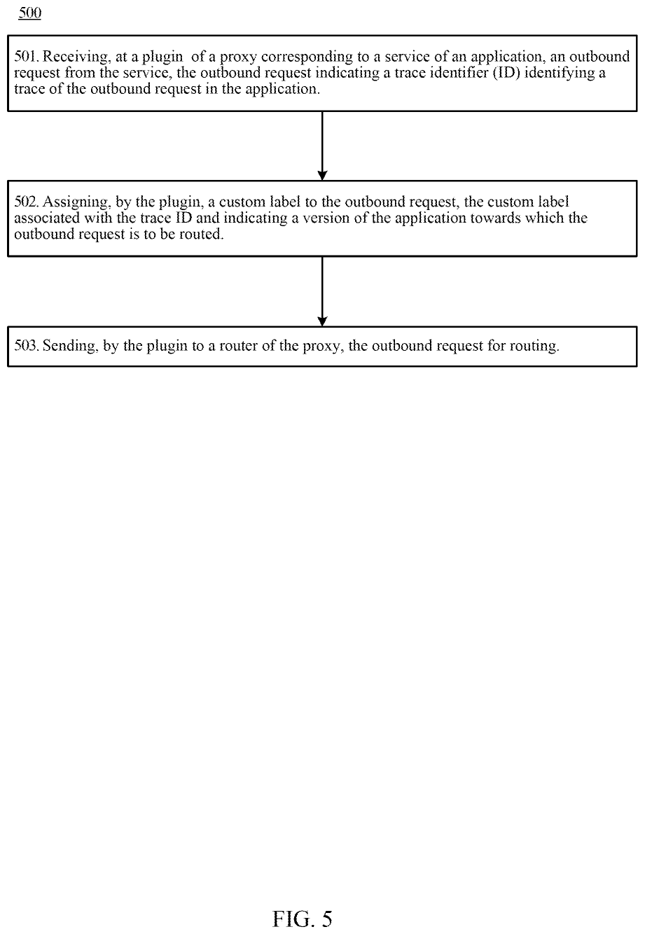

FIG. 5 illustrates a flowchart of a method 500 for propagating and routing traffic within an application, according to an embodiment. The method 500 includes receiving 501, at a plugin (e.g., full link WASM plugin 302) of a proxy (e.g., proxy 304) corresponding to a service (e.g., application service A V1 312) of an application, an outbound request (e.g., outbound request 319) from the service. The outbound request may indicate a trace identifier (ID) identifying a trace of the outbound request in the application. The method 500 may further include assigning 502, by the plugin, a custom label to the outbound request. The custom label may be associated with the trace ID and indicate a version of the application towards which the outbound request is to be routed. The method 500 may further include sending 503, by the plugin to a router of the proxy, the outbound request for routing.

The method 500 may further include obtaining, by the plugin, the custom label from a shared in-memory storage (e.g., memory storage 324) of the proxy. The method 500 may further include receiving, at the plugin, an inbound request (e.g., inbound request 316) corresponding to the outbound request. The inbound request may indicate the trace ID and the custom label. The method 500 may further include storing, by the plugin, the trace ID and the custom label in the shared in-memory storage. The method 500 may further include sending, by the plugin to the service, the inbound request for processing.

In some embodiments, the service may be a first version of a first service of the application. In some embodiments, the version of the application may be a second version of a second service of the application towards which the outbound request is to be routed. The second version may be the first version or a different version.

In some embodiments, the service may be a first service of a first version of the application. The first version of the application may include a first set of services of the application including the first service. In some embodiments, the custom label may indicate a second version of the application running in parallel to the first version of the application. The second version of the application may include a second set of services of the application.

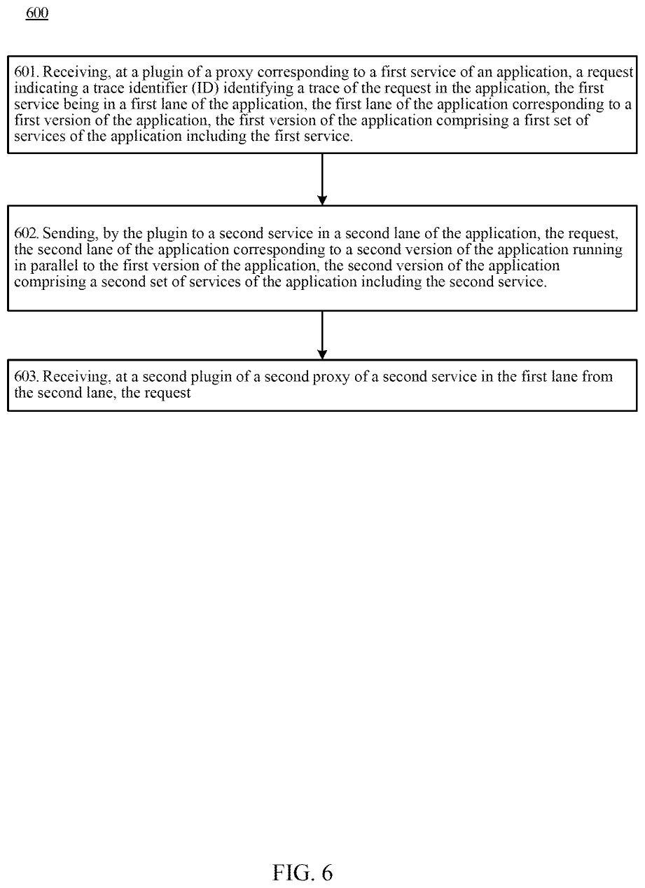

FIG. 6 illustrates a flowchart of a method for propagating and routing traffic within an application, according to an embodiment. The method 600 includes receiving 601, at a plugin of a proxy corresponding to a first service of an application, a request indicating a trace identifier (ID) identifying a trace of the request in the application. The first service may be in a first lane of the application. The first lane of the application may correspond to a first version of the application. The first version of the application may include a first set of services of the application including the first service. The method 600 may further include sending 602, by the plugin to a second service in a second lane of the application, the request. The second lane of the application may correspond to a second version of the application running in parallel to the first version of the application. The second version of the application may include a second set of services of the application including the second service. The method 600 may further include receiving 603, at a second plugin of a second proxy of a second service in the first lane from the second lane, the request.

In some embodiments, receiving, at the plugin of the proxy corresponding to the first service of the application, the request may include receiving, at the plugin (e.g., full link WASM plugin 320) of the proxy (e.g., proxy 304) corresponding to the first service (e.g., application service A V1 312) of the application, an inbound request (e.g., inbound request 316). The inbound request may indicate the trace ID and a custom label. The custom label may be associated with the trace ID and indicate the second version of the application towards which the request is to be routed. Receiving, at the plugin of the proxy corresponding to the first service of the application, the request may further include storing, by the plugin of the proxy corresponding to the first service, the trace ID and the custom label in a shared in-memory storage (e.g., memory storage 324). Receiving, at the plugin of the proxy corresponding to the first service of the application, the request may further include sending to the first service, by the plugin of the proxy corresponding to the first service, the inbound request for processing.

In some embodiments, sending, by the plugin to the second service in the second lane of the application, the request may include receiving, at the plugin of the proxy corresponding to the first service, an outbound request (e.g., outbound request 319) from the first service. The outbound request may indicate the trace ID. Sending, by the plugin to the second service in the second lane of the application, the request may further include obtaining, by the plugin of the proxy corresponding to the first service, the custom label from the shared in-memory storage. Sending, by the plugin to the second service in the second lane of the application, the request may further include assigning, by the plugin of the proxy corresponding to the first service, the custom label to the outbound request. Sending, by the plugin to the second service in the second lane of the application, the request may further include sending, by the plugin of the proxy corresponding to the first service to a router of the proxy, the outbound request for routing.

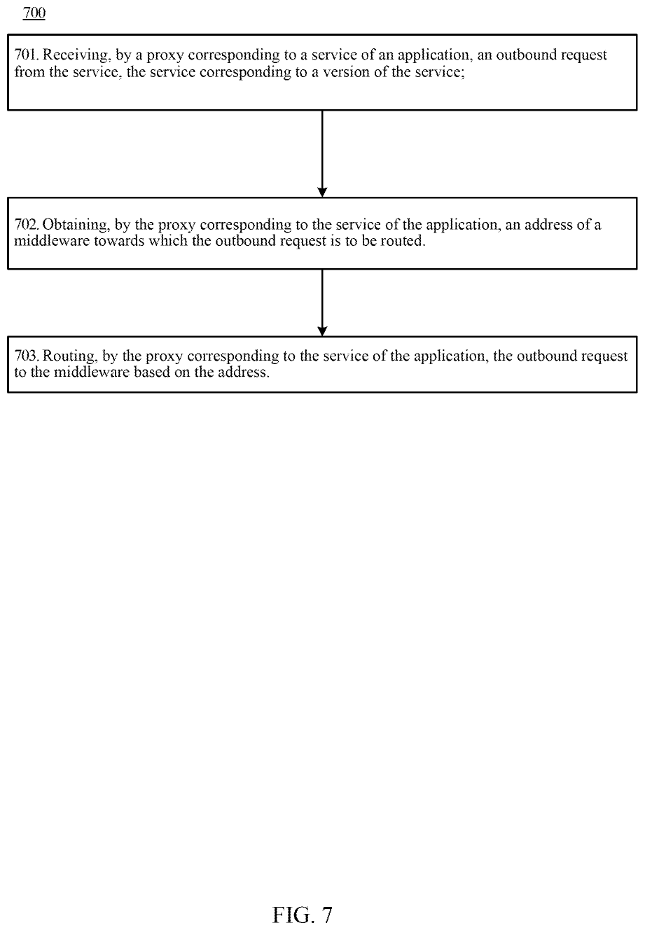

FIG. 7 illustrates a flowchart of a method for routing traffic from an application service to a middleware, according to an embodiment. The method 700 may include receiving 701, by a proxy corresponding to a service of an application, an outbound request from the service. The service may correspond to a version of the service. The method 700 may further include obtaining, by the proxy corresponding to the service of the application, an address of a middleware towards which the outbound request is to be routed. The method 700 may further include routing 703, by the proxy corresponding to the service of the application, the outbound request to the middleware based on the address of the middleware.

In some embodiments, obtaining, by the proxy corresponding to the service of the application, an address of a middleware towards which the outbound request is to be routed may include obtaining, by the proxy corresponding to the service of the application, a version of the middleware based on the version of the service. Obtaining, by the proxy corresponding to the service of the application, an address of a middleware towards which the outbound request is to be routed may further include obtaining, by the proxy corresponding to the service of the application, the address of the middleware based on the version of the middleware.

In some embodiments, obtaining, by the proxy corresponding to the service of the application, a version of the middleware based on the version of the service may include matching, by the proxy corresponding to the service of the application, the version of the service to the version of the middleware via a registry center (e.g., microservice registry center 103). The registry center may indicate a version of each: service of the application and middleware of the application.

In some embodiments, the method may further include receiving, by the proxy corresponding to the service of the application, a matching source label routing policy (e.g., matching source label routing policy 404). Matching, by the proxy corresponding to the service of the application, the version of the service to the version of the middleware may include matching according to the matching source label routing policy.

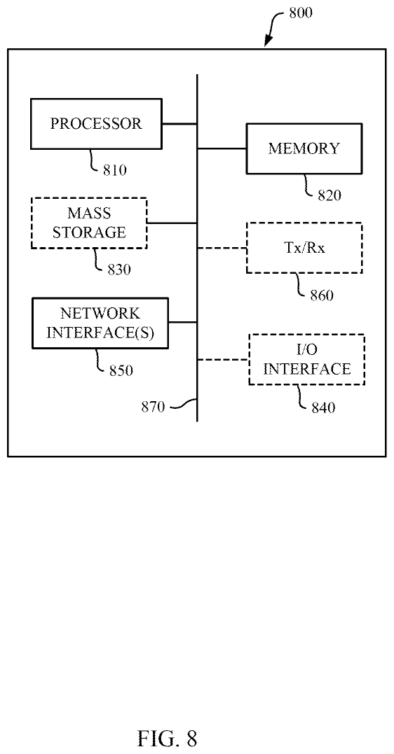

FIG. 8 illustrates an apparatus 800 that may perform any or all of operations of the methods and features explicitly or implicitly described herein, according to different aspects of the present disclosure. For example, a computer equipped with network function may be configured as the apparatus 800. In some aspect, apparatus 800 can be a device that connects to the network infrastructure over a radio interface, such as a mobile phone, smart phone or other such device that may be classified as user equipment (UE). In some aspects, the apparatus 800 may be a Machine Type Communications (MTC) device (also referred to as a machine-to-machine (m2m) device), or another such device that may be categorized as a UE despite not providing a direct service to a user. In some aspects, apparatus 800 may be used to implement one or more components, systems, mechanisms according to one or more aspects described herein. For example, apparatus 800 may be a proxy, a plugin, a system, or the like that performs one or more operations described herein.

As shown, the apparatus 800 may include a processor 810, such as a Central Processing Unit (CPU) or specialized processors such as a Graphics Processing Unit (GPU) or other such processor unit, memory 820, non-transitory mass storage 830, input-output interface 840, network interface 850, and a transceiver 860, all of which are communicatively coupled via bi-directional bus 870. Transceiver 860 may include one or multiple antennas According to certain aspects, any or all of the depicted elements may be utilized, or only a subset of the elements. Further, apparatus 800 may contain multiple instances of certain elements, such as multiple processors, memories, or transceivers. Also, elements of the hardware device may be directly coupled to other elements without the bi-directional bus. Additionally, or alternatively to a processor and memory, other electronics or processing electronics, such as integrated circuits, application specific integrated circuits, field programmable gate arrays, digital circuitry, analog circuitry, chips, dies, multichip modules, substrates or the like, or a combination thereof may be employed for performing the required logical operations.

The memory 820 may include any type of non-transitory memory such as static random-access memory (SRAM), dynamic random-access memory (DRAM), synchronous DRAM (SDRAM), read-only memory (ROM), any combination of such, or the like. The mass storage element 830 may include any type of non-transitory storage device, such as a solid-state drive, hard disk drive, a magnetic disk drive, an optical disk drive, USB drive, or any computer program product configured to store data and machine executable program code. According to certain aspects, the memory 820 or mass storage 830 may have recorded thereon statements and instructions executable by the processor 810 for performing any method operations described herein.

The processor 810 and memory 820 may function together as a chipset which may be provided together for installation into wireless communication apparatus 800 in order to implement WLAN functionality. The chipset may be configured to receive as input data including but not limited to PPDUs from the network interface 850. The chipset may be configured to output data including but not limited to PPDUs to the network interface 850.

Aspects of the present disclosure can be implemented using electronics hardware, software, or a combination thereof. In some aspects, this may be implemented by one or multiple computer processors executing program instructions stored in memory. In some aspects, the invention is implemented partially or fully in hardware, for example using one or more field programmable gate arrays (FPGAs) or application specific integrated circuits (ASICs) to rapidly perform processing operations.

It will be appreciated that, although specific embodiments of the technology have been described herein for purposes of illustration, various modifications may be made without departing from the scope of the technology. The specification and drawings are, accordingly, to be regarded simply as an illustration of the invention as defined by the appended claims, and are contemplated to cover any and all modifications, variations, combinations or equivalents that fall within the scope of the present invention. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Further, each operation of the method may be executed on any computing device, such as a personal computer, server, PDA, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

Through the descriptions of the preceding embodiments, the present invention may be implemented by using hardware only or by using software and a necessary universal hardware platform. Based on such understandings, the technical solution of the present invention may be embodied in the form of a software product. The software product may be stored in a non-volatile or non-transitory storage medium, which can be a compact disk read-only memory (CD-ROM), USB flash disk, or a removable hard disk. The software product includes a number of instructions that enable a computer device (personal computer, server, or network device) to execute the methods provided in the embodiments of the present invention. For example, such an execution may correspond to a simulation of the logical operations as described herein. The software product may additionally or alternatively include number of instructions that enable a computer device to execute operations for configuring or programming a digital logic apparatus in accordance with embodiments of the present invention.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. A method comprising:
receiving, at a plugin of a proxy corresponding to a service of an application, an outbound request from the service, the outbound request indicating a trace identifier (ID) identifying a trace of the outbound request in the application;
assigning, by the plugin, a custom label to the outbound request, the custom label associated with the trace ID and indicating a version of the application towards which the outbound request is to be routed; and
sending, by the plugin to a router of the proxy, the outbound request for routing.

2. The method of claim 1 further comprising:
obtaining, by the plugin, the custom label from a shared in-memory storage of the proxy.

3. The method of claim 2 further comprising:
receiving, at the plugin, an inbound request corresponding to the outbound request, the inbound request indicating the trace ID and the custom label;
storing, by the plugin, the trace ID and the custom label in the shared in-memory storage; and
sending, by the plugin to the service, the inbound request for processing.

4. The method of claim 1, wherein the service is a first version of a first service of the application, the version of the application is a second version of a second service of the application towards which the outbound request is to be routed, the second version being the first version or a different version.

5. The method of claim 1, wherein the service is a first service of a first version of the application, the first version of the application comprising a first set of services of the application including the first service.

6. The method of claim 4, wherein the custom label indicates a second version of the application running in parallel to the first version of the application, the second version of the application comprising a second set of services of the application.

7. A method comprising:
receiving, at a plugin of a proxy corresponding to a first service of an application, a request indicating a trace identifier (ID) identifying a trace of the request in the application, the first service being in a first lane of the application, the first lane of the application corresponding to a first version of the application, the first version of the application comprising a first set of services of the application including the first service;
sending, by the plugin to a second service in a second lane of the application, the request, the second lane of the application corresponding to a second version of the application running in parallel to the first version of the application, the second version of the application comprising a second set of services of the application including the second service; and
receiving, at a second plugin of a second proxy of a second service in the first lane from the second lane, the request.

8. The method of claim 7 wherein:
receiving, at the plugin of the proxy corresponding to the first service, the request comprises:
receiving, at the plugin of the proxy corresponding to the first service, an inbound request indicating the trace ID and a custom label, the custom label associated with the trace ID and indicating the second version of the application towards which the request is to be routed;
storing, by the plugin of the proxy corresponding to the first service, the trace ID and the custom label in a shared in-memory storage; and
sending, by the plugin of the proxy corresponding to the first service to the first service, the inbound request for processing.

9. The method of claim 8 wherein:
sending, by the plugin to the second service in the second lane of the application, the request comprises:
receiving, at the plugin of the proxy corresponding to the first service, an outbound request from the first service, the outbound request indicating the trace ID;
obtaining, by the plugin of the proxy corresponding to the first service, the custom label from the shared in-memory storage;
assigning, by the plugin of the proxy corresponding to the first service, the custom label to the outbound request, and
sending, by the plugin of the proxy corresponding to the first service to a router of the proxy, the outbound request for routing.

10. A method comprising:
receiving, by a proxy corresponding to a service of an application, an outbound request from the service, the service corresponding to a version of the service;
obtaining, by the proxy corresponding to the service of the application, an address of a middleware towards which the outbound request is to be routed; and
routing, by the proxy corresponding to the service of the application, the outbound request to the middleware based on the address of the middleware.

11. The method of claim 10, wherein obtaining, by the proxy corresponding to the service of the application, an address of a middleware towards which the outbound request is to be routed comprises:
obtaining, by the proxy corresponding to the service of the application, a version of the middleware based on the version of the service; and
obtaining, by the proxy corresponding to the service of the application, the address of the middleware based on the version of the middleware.

12. The method of claim 10, wherein obtaining, by the proxy corresponding to the service of the application, a version of the middleware based on the version of the service comprises:
matching, by the proxy corresponding to the service of the application, the version of the service to the version of the middleware via a registry center, the registry center indicating a version of each: service of the application and middleware of the application.

13. The method of claim 12 further comprising:
receiving, by the proxy corresponding to the service of the application, a matching source label routing policy, wherein:
matching, by the proxy corresponding to the service of the application, the version of the service to the version of the middleware comprises matching according to the matching source label routing policy.

14. An apparatus comprising processing electronics configured for:
receiving, at a plugin of a proxy corresponding to a service of an application, an outbound request from the service, the outbound request indicating a trace identifier (ID) identifying a trace of the outbound request in the application;
assigning, by the plugin, a custom label to the outbound request, the custom label associated with the trace ID and indicating a version of the application towards which the outbound request is to be routed; and
sending, by the plugin to a router of the proxy, the outbound request for routing.

15. A computer device comprising a non-transitory computer readable medium having instructions stored thereon which, when executed by a computer processor, causes the computer to configure a plugin of a proxy corresponding to a service of an application for:
receiving an outbound request from the service, the outbound request indicating a trace identifier (ID) identifying a trace of the outbound request in the application;
assigning a custom label to the outbound request, the custom label associated with the trace ID and indicating a version of the application towards which the outbound request is to be routed; and
sending the outbound request for routing.
